(19) United States
(12) Patent Application Publication
(10) Pub. No.: US 2011/0313712 A1
(43) Pub. Date: Dec. 22, 2011

(54) METHOD FOR DETERMINATION OF FLUID PROPERTIES IN A POROUS MEDIUM

(75) Inventors: Ivan Vladimirovich Nikolyn, Moscow (RU); Sergey Sergeevich Safonov, Moscow (RU)

(73) Assignee: Schlumberger Technology Corporation, Cambridge, MA (US)

(21) Appl. No.: 12/981,092

(22) Filed: Dec. 29, 2010

(30) Foreign Application Priority Data
Dec. 31, 2009 (RU) 2009149588

(51) Int. Cl. G06F 15/00

(52) U.S. Cl. 702/136

(57) ABSTRACT

A method for a fluid parameters determination in a porous medium includes phase transition temperature measurement of the fluid in question in the free space, saturation of the porous medium of the known pore space geometry with the fluid in question, measurement of the phase transition temperature of the fluid in question in the particular porous material and calculation of the wetting angle or interface tension of the fluid between the liquid and solid phases of the fluid in the porous medium.

### FIELD OF THE INVENTION

The invention is related to the field of studying the fluid surface behavior, particularly, to the determination of the interface tension and fluid wetting angle in porous medium and may find application in various areas, for example, chemical industry, oil and gas industry, paint and coatings industry and food industry.

### BACKGROUND OF THE INVENTION

Wetting is a surface phenomenon consisting in the fluid-to-surface interface. Wetting depends on the ratio of the fluid molecules' cohesion forces with the molecules/atoms of the wetted body to the fluid molecules' reciprocal cohesion forces.

The wetting degree is characterized by the wetting angle. Wetting angle (or contact wetting angle) is the angle formed by the tangent planes to interface surfaces limiting the wetting fluid and the angle vertex lies at the three phase interface line.

Interface (surface) tension is a thermodynamic characteristic of the two balanced phases interface, it is determined by the work of the reversing isokinetic formation of the area unit of this interface surface providing that the temperature, system volume and chemical potentials of all the components in both phases remain constant.

Thus, fluid wetting angle determination techniques by sessile drop method are known. The method consists in the determination of the shape and dimensions of the drop lying on the plate using optical systems, for example, microscope, or using the drop photograph. Modern installations are equipped with high-resolution cameras and software enabling wetting angle analysis (Richard Williams and Alvin Goodman, “Wetting of thin layers of SiO₂ by water”, Applied Physics Letters, Vol. 25. No. 10 (1974)).

Simultaneously, there are several methods of wetting angle measurement in powder media which, by their physical nature, may be considered as porous media.

One of the known methods consists in the necessity to compact the powder and measure the wetting angle at the surface, for example, using sessile drop method.

There are also methods of the fluid wetting angle determination in powder media known as Washburn Method [Washburn, E. W., Phys. Rev. 19, 374 (1921) and Bartell Method [Bartell F. E., and Walton C. W., J. Phys. Chem. 38, 503 (1934)], that are based on the fluid absorption by the powder. They differ only in the fact that Washburn Method is a dynamic method whereas Bartell Method is a static method. In the dynamic method the powder wetting angle measurement is determined through the fluid absorption rate and in static method—through pressure required to terminate the fluid absorption process.

The disadvantages of the method above include length of the method implementation and complexity of the equipment used to implement it which results in excessive capital expenses for the method implementation in general. Simultaneously, the measurement result using these methods is influenced by the design peculiarities of the experiment cell and equipment which causes reduced accuracy of the results obtained.

As far as interface fluid tension in porous media is concerned it is worth mentioning that in the prior art the applicant did not find methods for the fluid porous media interface tension determination.

### SUMMARY OF THE INVENTION

The implementation of the method claimed provides for improved accuracy, reliability and response time of the interface tension and porous medium fluid wetting angle determination.

The method comprises the steps of measurement of the phase transition temperature Tₒ of the fluid in question in the free space, saturation of the porous material of the known pore space geometry with the fluid in question, then phase transition temperature Tₘ of the fluid in question in this porous material is measured. Wetting angle θ or interface fluid tension between the fluid liquid and solid phases in the porous medium Υₛₗ is calculated by formula:

$$Δ T = \frac{2 {T}_{0} {γ}_{s 1} }{ρ \cdot Δ H} \frac{Cos θ}{{r}_{p}} ,$$

where ΔTₘ—is the pore fluid melting temperature shift, equal to Tₒ−Tₘ, ρ—fluid density, ΔH—specific heat of the pore fluid phase transition, rₚ—effective pore radius equal to (R−t), R—pore radius, t—thickness of the fluid unfrozen stratum.

Hereby to calculate the wetting angle the interface tension value determined by any known method, for example, plate balancing method is used.

And to calculate the interface tension between the liquid and solid phases of the fluid in the porous medium the wetting angle value calculated using any known method, for example, drop method, is used.

### DETAILED DESCRIPTION OF THE PREFERRED EMBODIMENTS

The invention claimed is clarified by the following drawings:

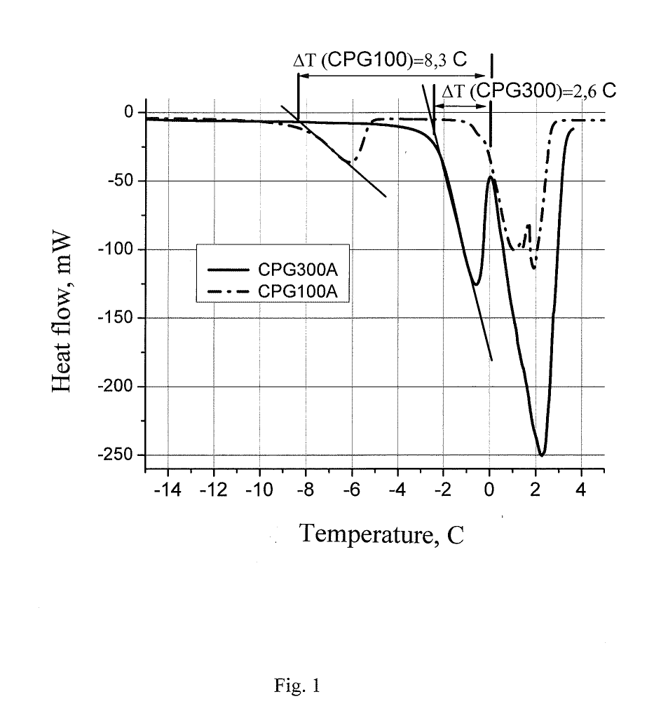

FIG. 1—Melting temperature shift in samples CPG100A and CPG300A.

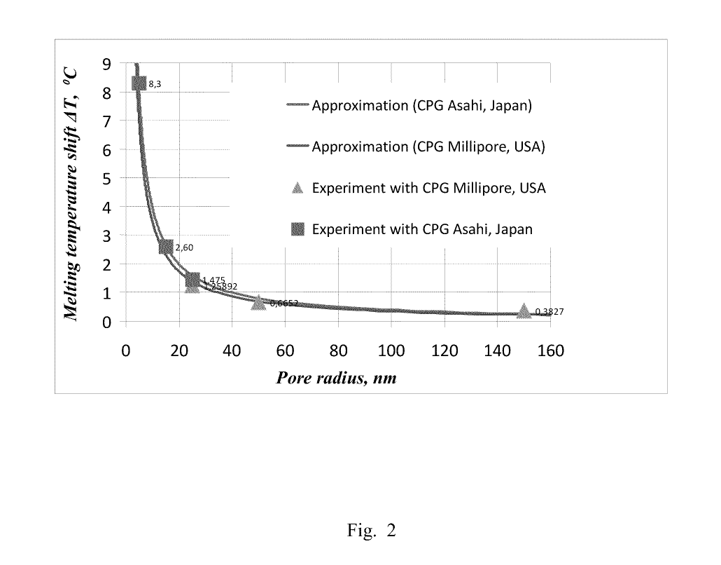

FIG. 2—Melting temperature change as function of pore radius in the porous samples in question.

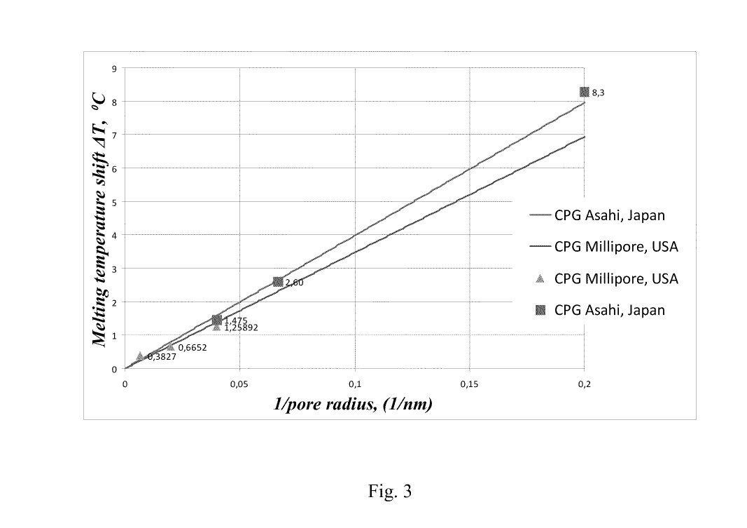

FIG. 3—Melting temperature change as function of the reverse value of the pore radius in the porous samples in question.

It is known that during the setting of the problem to determine the pore structure (geometric dimensions) of the porous medium this characteristic may be obtained through the melting temperature or pore fluid freezing temperature shift.

The theoretical dependence of the pore fluid phase transition temperature on the pore dimensions is known as Gibbs-Thomson equation:

ΔTₘ=Tₒ−Tₘ=2·Tₒ·Υₛₗ−θₗ/R·ΔH, (1)

where Tₒ, is the volume fluid melting temperature, Tₘ—pore fluid melting temperature, Υₛₗ—free surface energy (interface tension at the surface dividing the fluid different phases during the phase transition (for example, ice-water), θₗ—fluid specific volume, R—characteristic pore size, ΔH—pore fluid phase transition specific heat.

Therefore, the problem of the porous medium pore size determination based on the possibility of the fluid (volume and pore) temperature shift using known, for example, calorimetric, methods enables the pore size determination using equation (1).

It is worth mentioning that in numerous studies [K. Ishikiriyama, M. Todoki, K. Motomura. <<Evaluation of thermoporometry for characterization of mesoporous materials>> J. Colloid Interface Sci. 171 (1995) p. 92] the existence of unfrozen fluid stratum (0.5-2 nm) is pointed out. This correction should be accounted for in case of the pore small size. Considering the unfrozen stratum thickness—t, the radius of the matter solid phase is reduced by the respective value. Then, including the correction, Gibbs-Thomson equation looks as follows:

ΔTₘ=2·Tₒ·Υₛₗ·θₗ/(R−t)·ΔH (2)

Equations received experimentally in a number of studies in their structure are aligned with Gibbs-Thomson equation:

$$R = \frac{A}{Δ {T}_{m}} + t , \qquad ( 3 )$$

Where A factor depends on the properties of the substance filling the pores [5,7]:

A=2·Tₒ·Υₛₗ−θₗ/ΔH (4)

Simultaneously an equation similar to Gibbs-Thomson equation accounting for the dependence between the melting temperature shift and cylindrical; pores radius is known:

ΔTₘ=2·Tₒ·Υₛₗ·Cos(θ)/(R−t)·ρ·ΔH, (5)

where Tₒ is the volume fluid melting temperature, ΔTₘ—the pore fluid melting temperature shift, Υₛₗ—free surface energy (interface tension at the ice-water surface), θₗ—fluid specific volume, R—pore radius, ΔH—pore fluid phase transition specific heat, t—fluid unfrozen stratum thickness, θ—wetting angle, ρ—fluid density.

Equation (5), considering the pore radius reduction by the unfrozen fluid stratum thickness, looks as follows:

$$Δ T = \frac{2 {T}_{0} {γ}_{s 1} }{ρ \cdot Δ H} \frac{Cos θ}{{r}_{p}} , \qquad ( 6 )$$

where rₚ is effective pore radius equal to (R−t).

Thus, the pore dimensions may be known in case of using a known material with the distinct pore dimensions or strictly specified pore dimensions, or determined using one of the known methods [D. R. Milburn, B. D. Adkins, B. H. Davis, in: F. Rodriguez-Reinoso, et al. (Eds.), Characterization of Porous Solids, vol. II, Elsevier Science, Publishers B.V., Amsterdam, 1991, pp. 543-551].

Volume fluid melting temperature Tₒ, pore fluid melting temperature Tₘ, may be measured using known methods, for example, calorimetric ones [Patrick Kent Gallagher <<Handbook of Thermal Analysis and calorimetry>> vol. 1 Principles and Practice Elsevier (1998) p. 618]. Pore fluid melting temperature shift ΔTₘ—is calculated as (Tₒ−Tₘ).

Fluid density (ρ) and its phase transition specific heat (ΔH) are table data and may be determined, for example, by the physical values reference book [Physical Values: Reference Book Edited by I. S. Grigoryev, E. Z. Meilikhov, Energoatomizdat (1991)].

Therefore, the applicant claims using the set equation (6) to determine the fluid interface tension at ice-fluid surface Υₛₗ—or wetting angle θ (via Cos θ).

Thus, measuring the fluid phase transition temperatures in the free space (volume) and pore medium, knowing the fluid phase transition heat, fluid density and pore geometric dimensions we determine:
interface tension between the fluid liquid and solid phases in the porous medium during the determination of the wetting angle of the pore space surface with the fluid using a known method, for example, sessile drop method, or
wetting angle of the pore space surface with the fluid in the pore space during the determination of the interface tension between the fluid liquid and solid phases using a known method applied for other media, for example, plate balancing method (Wilhelmy method) [N. R. Pallas, Colloids & Surfaces, Vol 6, 221-227 (1983)] or anchor-ring method (Du Nouy Method). [W. D. Harkins, H. F. Jordan, J. Amer. Chem. Soc., 52, 1751 (1930)].

A number of experiments to measure the water melting temperature in the pore space with the known pore size were conducted.

CPG (controlled pore glasses) from two different manufacturers—Millipore (the USA) and—Asahi (Japan) (CPG500C, CPG1000C, CPG3000C from Millipore and CPG100, CPG300, CPG500 from Asahi) were used as reference samples with the known pore dimensions.

Pore water melting temperature was measured as per international standard ISO 11357-1 for the determination of the phase transition temperature using a differential scanning calorimeter (DSC) [International Standard ISO 11357 <<Plastics—Differential scanning calorimetry (DSC)”.

FIG. 2 and FIG. 3 contain the values of the experimentally determined melting temperature shifts for the samples with different pore dimensions (three Millipore samples and three Asahi samples) as well as approximation of the experimental data for each of the three-sample set built as per the following equation:

$$Δ T = \frac{2 {T}_{0} {γ}_{s 1} }{ρ \cdot Δ H} \frac{Cos θ}{{r}_{p}} ,$$

Water-ice interface tension as per the method described in [W. D. Harkins, H. F. Jordan, J. Amer. Chem. Soc., 52, 1751 (1930)] made list Υₛₗ=60.5 mJ/m². Based on the table data for ρ and (ΔH) for water [Physical Values: Reference Book Edited by I. S. Grigoryev, E. Z. Meilikhov, Energoatomizdat (1991)], wetting angles were calculated which made θ=33 deg. and θ=43 deg., respectively for Millipore and Asahi samples.

In the next example the wetting angle is measured using sessile drop method and is equal to 28 deg., which corresponds to the data in [N. Dumitrascu, C. Borcia <<Determining the contact angle between liquids and cylindrical surfaces>> Journal of Colloid and Interface Science 294 (2006) p. 418-422.]. Based on the table data for ρ and (ΔH) for water [Physical Values: Reference Book Edited by I. S. Grigoryev, E. Z. Meilikhov, Energoatomizdat (1991)], water-ice interface tension was calculated which amounted to 57.5 mJ/m².

What is claimed is:

1. A method for fluid properties determination in a porous medium comprising the steps of:
measuring a phase transition temperature Tₒ of the fluid in question in the free space,
saturating the porous medium of the known pore space geometry with the fluid in question,
measuring a phase transition temperature Tₘ of the fluid in question in this porous medium,
calculating the wetting angle θ or the fluid interface tension between the liquid and solid phases of the fluid in the porous medium Υₛₗ based on the formula:
$$Δ Tm = \frac{2 {T}_{0} {γ}_{s 1} }{ρ \cdot Δ H} \frac{Cos θ}{{r}_{p}} ,$$
where ΔTₘ—is the pore fluid melting temperature shift, equal to Tₒ−Tₘ, ρ—the fluid density, ΔH—specific heat of the pore fluid phase transition, rₚ—effective pore radius equal to (R−t), R—a pore radius, t—thickness of the fluid unfrozen stratum, hereby to calculate the wetting angle the interface tension value determined by any known method is used, and to calculate the interface tension between the liquid and solid phases of the fluid in the porous medium the wetting angle value calculated using any known method is used.

2. The method of claim 1, wherein the known method for the interface tension determination is a plate balancing method.

3. The method of claim 1, wherein the known method for the wetting angle determination is a drop method.
